(19) United States
(12) Patent Application Publication
(10) Pub. No.: US 2017/0255760 A1
(43) Pub. Date: Sep. 7, 2017

(54) Automatic Drug Dispensing System with Medicine Verification

(71) Applicant: Zyno Medical, LLC, Natick, MA (US)

(72) Inventors: Chao Young Lee, Weston, MA (US); Mei Zhang, Sharon, MA (US)

(21) Appl. No.: 15/444,886

(22) Filed: Feb. 28, 2017

Related U.S. Application Data
(60) Provisional application No. 62/304,409, filed on Mar. 7, 2016.

(51) Int. Cl. G06F 19/00; A61J 1/22; A61J 1/20

(52) U.S. Cl. CPC G06F 19/3456; G06F 19/322; A61J 1/2003; A61J 1/22

(57) ABSTRACT

A system for automatic verification of medicine type and/or concentration by automatic drug dispensing systems contemporaneous with the compounding and dispensing of the medicine from the system.

### CROSS REFERENCE TO RELATED APPLICATION

This application claims the benefit of U.S. provisional application 62/304,409 filed Mar. 7, 2016 and hereby incorporated by reference.

### BACKGROUND OF THE INVENTION

The present invention relates to machines for the automatic dispensing and compounding of medicines and in particular to a machine providing increased safety against drug counterfeiting and diversion.

Increasingly, medicines for use in a hospital or clinical setting are automatically dispensed by robotic equipment. For example, such equipment may receive pharmacy orders associated with particular patients, and dispense a proper number of pills for multiple drugs into containers or pouches sized to meet that specific order. The pouches are labeled clearly with respect to the patient and logged automatically in a record system. In this way, medicine errors may be significantly reduced and the risk of drug diversion or loss decreased.

Some medicines must be compounded immediately before use in order to retain their efficacy. In these cases, it is known to prepare an automatic dispensing system by taking vials containing powdered medicine and mixing them with a diluent which may then be loaded into a syringe for dispensing.

As part of these automatic processes, the dispensing system may provide multiple checks confirming the proper drugs and diluent. Initially, the system confirms that the correct diluent reservoir and drug vial has been connected to the system by comparing the drug containers against the prescription order. This may be accomplished by scanning a barcode on the IV bag or bottle or using image capture technology of the IV bags or bottle. Once the identity of the drug container is confirmed against the drug prescription, the automatic drug dispensing system transfers the vial to fluid transfer stations where a diluent is injected into the vial, mixed to reconstitute the drug, and aspirated into a syringe. The aspirated dose may be diluted in the syringe to a prescribed total volume. The syringe is then moved to the labelling station where pertinent clinical information is printed and labelled. A safety check may be performed by a bed side barcode scanning system where the drug is again confirmed just prior to administration to the patient.

### SUMMARY OF THE INVENTION

The present inventors have recognized that effectiveness of the confirmation systems currently built into automatic medicine dispensing systems are critically reliant on the drugs and diluent being properly labeled. This reliance may be misplaced in cases where counterfeit drugs enter the supply chain or labeling is tampered with, for example, through reuse of medicine vials or their labels or counterfeit label production. While it is impractical to fully analyze every drug automatically at the time of dispensing, the present inventors have recognized that chemically revealing signatures can be obtained particularly of liquid medicaments, for example, by Ramen spectroscopy. The signatures, which are not apparent from simple visual inspection, provide a strong obstacle against counterfeiting or vial reuse

The signature verification can occur when connecting drug containers to the system and prior to labeling and dispensing the finished drug container from the system to ensure additional safety checks. These safety checks may be accomplished through compact automated sensor systems such as Raman spectrometers integrated within the automatic dispensing system.

Accordingly, the present invention provides a system for automatic verification of medicine type and/or concentration by automatic drug dispensing systems contemporaneous with the compounding and dispensing of the medicine from the system. Automatic drug dispensing systems may include a manipulator that transports medical containers such as bags, vials, or syringes about a substantially aseptic compounding chamber. In a preferred implementation, a gripper assembly is configured to grasp and retain syringes, IV bags, and vials of varying shapes and sizes. The gripper assembly may place the syringes, IV bags, and vials in or near fluid transfer stations including, e.g., mixers/shakers, de-cappers, de-needlers, syringe manipulators, etc., within the compounding chamber that assist in mixing and compounding the various drugs according to a drug order or prescription. Once the identity of the medicine is confirmed, a labeler within the system may label the drug container with drug identification and drug delivery information before being dispensed from the system.

In one embodiment, a medicine signature sensor is incorporated into the automatic drug dispensing systems preparing the medicine, labelling the drug containers, and dispensing the medicine from the system to the medical profession so that medicine type and formulation information can be verified during drug preparation. For example, the medicine signature sensor is incorporated into the drug mixing system to ensure the correct drug/drug concentration is used before, during and after batch filling or mixing.

By independently assessing the medicine characteristics before, during, and after the compounding process, the present invention addresses a wide range of tampering or other errors that can occur during drug preparation but before delivery to the medical professional. These error may include counterfeit drugs, improper labelling of drug containers delivered to the pharmacy, tampering of drug containers delivered to the pharmacy, or incorrect scanning of reservoirs or vials during drug intake. By taking advantage of a central medical database indicating the type of drug intended to be delivered to the patient, an automated medicine signature sensor becomes practical, needing only to distinguish between specific categories of drugs and formulations rather than providing a full chemical analysis. A trade-off between false positive error detection and comprehensive elimination of errors can be flexibly implemented.

Specifically, in one embodiment, the invention provides an automatic drug dispensing apparatus comprising a cabinet holding a plurality of drugs in labeled containers providing machine-readable labels indicating drug contents, the cabinet providing limited access for restricting unauthorized personnel; a manipulator adapted to transport at least one drug from the cabinet to aid dispensing outlet for receipt of the drug by medical personnel; a sensor adapted to extract a drug signature dependent on the formulation of the drug by measuring the properties of the drug imperceptible to a human observer; and an electronic computer executing a stored program to: (1) receive a nominal identity of a drug to be dispensed; (2) control the manipulator to select from the cabinet a container having a label matching the nominal identity; (3) obtain from the sensor a measured drug signature of the selected drug in the drug container; (4) use the nominal identity to determine a correct drug signature associated with the drug and to compare the correct drug signature with the measured drug signature; and (5) provide an output indicating if the correct drug signature differs from the measured drug signature by a predetermined amount.

It is thus a feature of at least one embodiment of the invention to address the problem of drug counterfeiting and mislabeled drugs in the automatic dispensing of drugs not addressed by current label-based systems.

The electronic computer may further combine a medicine and diluent and measure the signature of the combined liquid medicine.

It is thus a feature of at least one embodiment of the invention to allow for analysis techniques that are suitable for solutions and more difficult with dry form medicines.

The nominal identity includes chemical formulation and concentration and selecting a signature based on both formulation and concentration.

It is thus a feature of at least one embodiment of the invention to allow dilution errors to be detected.

A labeler may be configured to write the measured drug signature to a label on the plurality of drug containers.

It is thus a feature of at least one embodiment of the invention to provide a simple method of communicating audit results immediately after the drug signature is confirmed to reduce the risk of tampering between drug scanning and labeling.

The measured drug signature may be a function of the chemical formulation of the drug. The correct drug signature and measured drug signature do not uniquely characterize the chemical formulation of the drug.

It is thus a feature of at least one embodiment of the invention to provide the benefits point of delivery auditing using achievable current technology recognizing that successful auditing need not require a comprehensive chemical analysis.

The correct drug signature and measured drug signature are a function of both chemical formulation and amount of the drug.

It is thus a feature of at least one embodiment of the invention to provide an auditing both as to the chemical formulation of the medicine but also its amount (possibly a combination of concentration and weight) to detect not only medication type errors but also dosage or diversion issues.

A scale for measuring a weight of the drug and wherein the measured signature and correct signature include weight components. The manipulator may be supported by the scale.

It is thus a feature of at least one embodiment of the invention to provide an additional audit built into the system which detects errors in drug amount that may be due to dilution issues.

The sensor may be a spectrometer. The spectrometer may be selected from the group consisting of: Raman spectrometers, surface enhanced Raman spectrometers, nuclear magnetic resonance spectrometers, and optical spectrometers.

It is thus a feature of at least one embodiment of the invention to provide sophisticated chemical analysis of a contain drug amenable to non-contact measurements, for example through a drug container, and for medicines in liquid form.

Actuable grippers may be configured to move together and apart to grasp the plurality of drug containers.

It is thus a feature of at least one embodiment of the invention to incorporate drug signature scanning into the automated movement of currently employed drug delivery systems to leverage current automation.

A network circuit for communicating with a remote electronic medical record system identifying a patient, prescribed drug, and prescription expiration for the prescribed drug may be provided where the correct drug signature is determined from the remote electronic medical record system.

It is thus a feature of at least one embodiment of the invention to provide a central server for drug signatures allowing a wide variety of different types of drugs to be audited.

The output may be provided through the communication circuit to the remote electronic medical record system for recordation in the electronic medical record system.

It is thus a feature of at least one embodiment of the invention to provide an audit record of medicine delivery tied to point of delivery analysis of the medicine.

An alternative embodiment of the present invention provides a method of automatic drug dispensing comprising the steps of: (1) providing an automatic drug dispensing apparatus comprising a cabinet holding a plurality of drugs in labeled containers providing machine-readable labels indicating drug contents, the cabinet providing limited access for restricting unauthorized personnel; a manipulator adapted to transport, at least one drug from the cabinet to aid dispensing outlet for receipt of the drug by medical personnel; a sensor adapted to extract a drug signature dependent on the formulation of the drug by measuring the properties of the drug imperceptible to a human observer; and an electronic computer executing a stored program; (2) receiving a nominal identity of a drug to be dispensed; (3) controlling the manipulator to select from the cabinet a container having a label matching the nominal identity; (4) obtaining from the sensor a measured drug signature of the selected drug in the drug container; (5) using the nominal identity to determine a correct drug signature associated with the drug and to compare the correct drug signature with the measured drug signature; and (6) providing an output indicating if the correct drag signature differs from the measured drug signature by a predetermined amount.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

### BRIEF DESCRIPTION OF THE FIGURES

FIG. 1 is a simplified representation of the hospital environment showing a medical pump and a medicine verification appliance receiving information from a central medical records system holding an electronic medical record file;

FIG. 2 is a block diagram of the functional components of the medical pump of FIG. 1 according to one embodiment of the invention in which the medical pump provides real-time medicine signature analysis;

FIG. 3 is a perspective view of a second embodiment of the medicine verification appliance shared among medical pumps for providing contemporaneous medicine signature analysis;

FIG. 4 is a simplified cross-sectional view of the appliance of FIG. 3 showing principle functional components of this appliance;

FIG. 5 is a flowchart of the steps of operation of the device of FIGS. 2, 3 and 4 in implementing the present invention to provide patient-specific alerts;

FIG. 6 is a diagram of a signature space showing regions allowing distinctions between drug types and formulations using a multidimensional signature; and

FIG. 7 is a fragmentary perspective view of a robotic manipulator used in an automatic drug dispensing system incorporating the medical signature analysis system of the present invention;

FIG. 8 is a simplified block diagram of the components of the robotic manipulator of FIG. 7;

FIG. 9 is a simplified block diagram of the automatic drug dispensing system including an inventory rack holding drug containers for interaction with the robotic manipulator of FIG. 7; and

FIG. 10 is a flowchart of the steps of operation of the device of FIGS. 7, 8 and 9 in implementing the present invention with an automatic drug dispensing system.

### DETAILED DESCRIPTION OF THE PREFERRED EMBODIMENT

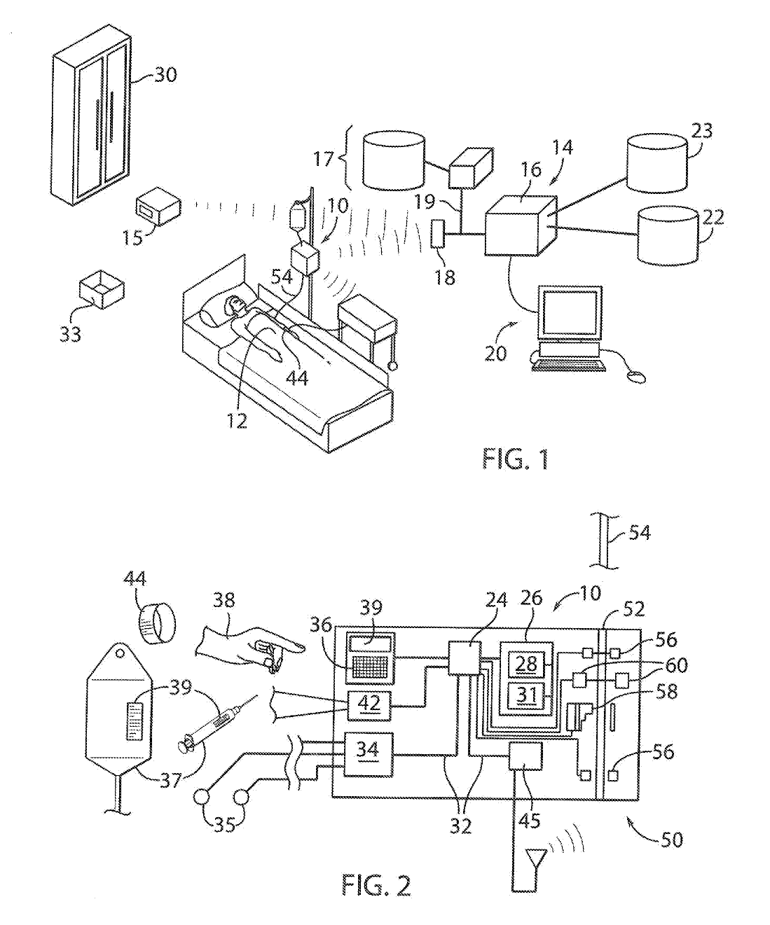

Referring now to FIG. 1, medical pump 10 may be positioned adjacent to a patient 12 for delivering medicine to a patient. The medical pump 10, as depicted, may be a peristaltic infusion pump for medicine delivery or may be a syringe pump or other similar device for the delivery of medicine to the patient under computerized control.

Each given medical pump 10 may communicate with databases of a central medical record system 14 in the healthcare facility or an external medicine database 17 (for example managed by a third-party) via the internet 19. This communication may be b a variety of means including electrical or optical cables or, as shown, wireless communication, or a combination of both.

The central medical record system 14 may, for example, provide a medical record server 16 communicating via wireless transceiver 18 with the medical pumps 10 and by a standard network circuit or the like with multiple data terminals 20 that may be staffed by healthcare personnel. The healthcare personnel may enter or access patient medical records and read alerts and monitor operation of the medical pumps 10 or the like.

The medical record server 16 may communicate with an electronic medical record database 22 holding patient medical records linked to patient identification numbers. As a general matter, medical record database 22 will link a patient identifier uniquely identifying a patient with various clinical information about the patient including: weight, height, gender, age, disease, therapy, allergies and the like.

The medical record server 16 may also communicate with a drug database 23 with information regarding “pharmacy orders” for specific drugs for particular patients. In the case of treating the patient by the introduction of a liquid medicament, for example, using a medical pump 10, the drug database 23 may hold data indicating types of drugs (e.g., their chemical identity), their formulation (e.g., concentration or delivery medium), and their preferred delivery rates in rate and total quantity as a function of particular static predicate data (such as patient gender or weight) and real-time predicate data such as blood pressure, glucose level and the like. Some or all of this information may also be obtained to the external medical database 17

The drug database 23 or external medical database 17 may also hold signature characteristics of the drugs being measurable parameters of the drug that reflect the drug type and formulation. As will be discussed further below, the signature characteristics of the drug will be a function of the drug chemical composition, concentration and amount but do not necessarily provide unique identification of those qualities but rather represent a simplified set of data points suitable for auditing.

Generally the drug database 23 is linked to the electronic medical record database 22 to receive pharmacy orders, for example, from physicians and linked to a pharmacy system allowing a pharmacist or other dispenser to receive the pharmacy orders to fill them and to mark them as dispensed. The drug database 23 may provide for inventory control as is generally understood in the art. It will be appreciated that the drug database 23 alternatively may be incorporated into the electronic medical database 22.

Logically the medical record database 22, the drug database 23, and the external medical database 17 serve to provide a logical electronic medical record 25, for example providing a logical row for each patient associated with patient information (patient ID, name, weight, height, gender, age, disease, therapy, allergies and the like) medicine delivery orders, order expiration dates (prescription expiration dates), signatures for the medicines to be delivered, and audit logs of release of the drugs from the pharmacy, the delivery of the drugs to the patient or the destruction of those drugs.

Infusion pumps that may communicate with centralized databases suitable for use with the present invention are described in U.S. Pat. Nos. 8,652,093, 8,945,043 and 8,469,933, all hereby incorporated by reference. Syringe pumps suitable for use with the present invention are described in co-pending patent application Ser. No. 13/659,619 filed Oct. 24, 2012, and entitled: “Syringe Pump with Improved Flow Monitoring” hereby incorporated in its entirety by reference.

Referring still to FIG. 1, the wireless transceiver 18, in one embodiment, may also communicate with a freestanding medicine verification appliance 15, for example, so that the medicine verification appliance 15 may wirelessly exchange data with the drug database 23 and the central electronic medical record database 22 in the same manner as the medical pumps 10. The medicine verification appliance 15 may be positioned so as to be shared among nearby medical pumps 10 and/or to be proximate to a medicine repository 30 either being a dispenser of drugs or a storage area for drugs that have been dispensed. Ideally the medicine verification appliance 15 is close enough to the patients 12 that medicine can be verified immediately before administration. Alternatively or in addition, the medicine verification appliance 15 may be positioned near a secured disposal container 33 so that the medicine verification appliance may be used to verify proper disposal of unused or expired medicines.

Referring now to FIG. 2, the medical pumps 10 may generally include a processor 24 communicating with a memory 26, the latter holding a program 28 providing an operating system for the medical pump 10 and specific executable programs for medicine verification as will be described below. The memory 26 may also hold data structures 31 used by the program 28 as will be described below.

The processor 24 may communicate via various I/O lines 32 which also allow the processor 24 to control or monitor different components of the medical pump 10 including air interface 34 to local patient monitors 35. Such patient monitors may include, for example, sensors measuring blood oxygen, blood pressure, pulse rate, respiration, ECG and patient temperature and may be used to provide for improved automatic control of the medicine being delivered by the medical pump 10 including, for example, painkillers, antibiotics, chemotherapy, anesthesia agents and the like.

The processor 24 may also communicate with a data entry keypad 36, for example, a membrane switch array, allowing data to be entered by medical personnel 38 associated with a particular task to be executed by the medical pump 10. The data entry keypad 36 may be associated with an output screen (such as an LCD alphanumeric display) for facilitating the data entry and review and for providing output to medical personnel 38. A more advanced touch screen may be used for inputting and displaying information. The data entry keypad 36, for example, may be used to enter patient identification information, medicine information, and medicine delivery rate or volume, in the case of a medical pump.

The processor 24 may further communicate with a context sensor 42 which may provide important contextual information about the environment of the medical pump 10. Context sensor 42 may, for example, be an RFID tag reader for reading labels 39 on medicine containers 37, for example, as held in an IV bag or syringe or held in a wristband 44 on the patient 12 (shown in FIG. 1). The labels 39 may include medicine type and concentration or other formulation details of the drug in the container 37 and may further include an intended date of delivery and patient identifier identifying the patient to receive the drug. The wristband 44 may provide for a patient identification number that may be used to index one or both of medical record database 22 and drug database 23. It will be understood that the labels 39 need not actually contain this information but may alternatively provide an index to the drug database 23 as discussed above so that this information may be retrieved wirelessly. Alternatively, the context sensor 40 may be may be a barcode reader, for example, for scanning a barcode label 39 on the medicine containers and wristband 44 on a patient 12 (shown in FIG. 1), or the IV bag or syringe medicine containers 37 or the like. The wristband 44 may provide for a patient identification number that may be used to index one or both of medical record database 22 and drug database 23.

The labels 39 on the medicine containers 37 may include medicine type and concentration or other formulation details of the drug in the container 37 and may further include an intended date of delivery and patient identifier identifying the patient to receive the drug. In some embodiments, the labels 39 may indicate a measured signature of the drug obtained from the separate medicine verification appliance 15. It will be understood that the labels 39 need not actually contain the described information but may alternatively provide an index to the drug database 23 or medical record database 22 (or the electronic medical record 25) as discussed above so that this information may be retrieved wirelessly. When the labels 39 contain the actual information or link to that information through a separate database, the packages are effectively associated with the data printed on or linked to the label.

The processor 24 may also communicate with a wireless transceiver 45, for example, a ZigBee, Wi-Fi, Bluetooth, Near Field Communication (NFC) or 3G device suitable for communicating'with the other medical pumps 10 and/or the wireless transceiver 18 of the medical record server 16. The wireless transceiver 45 may also be used to communicate with the patient monitors 35.

Referring still to FIG. 2, the medical pump 10 may include a pump section 50, for example, for an IV pump, the pump section 50 providing a channel to receive an IV line 54 therethrough. Positioned across the channel 52 may be one or more sensors 56, for example, for detecting fluid pressure, bubbles, and the presence or absence of the IV line 54 itself. These sensors may communicate with the processor 24 which may control a pump actuator element 58, for example, being a peristaltic pump mechanism, that may pump liquid through the IV line 54 by a series of progressive compressions of the IV line 54 in the manner of peristalsis.

Significantly, positioned across the channel 52 may be a medicine signature detector 60 that can evaluate the medicine type and composition of the medicine. In one embodiment, the medicine signature detector 60 may be a compact Raman Spectrometer relying on Raman scattering of a laser projected through the IV line 54 to a corresponding sensor. The IV line 54 may provide a specially prepared window for the purpose of allowing the transmission of the necessary light. Compact Raman spectrometers suitable for this purpose are commercially available through a number of vendors including, for example, Ocean Optics under the tradename of IDRaman mini handheld Raman spectrometer.

Alternatively, the medicine signature detector 60 may make use of a variety of other sensor technologies including but not limited to: surface enhanced Raman spectroscopy using a treated IV line 54, nuclear magnetic resonance, optical absorption spectroscopy or other sensing systems. These systems may be used alone or in various combinations. When surface enhanced RAM and spectroscopy is used, the IV line 54 may be specially treated for example to provide a drug contacting rough metal surface or nano structure, such as plamonic-magnetic silica nanotubes to enhance the sensitivity of the spectroscope. Other reagents and reactants can be coded on the inner surface of the IV line 54 for example for the purpose of optical spectroscopic measurements. Generally, the measurements contemplated by the present invention can be performed without breaching the sterile envelope defined by the IV line 54 or the drug container possibly through the use of special windows are optical sections therein.

Generally the medicine signature detector 60 may provide quantitative outputs that permit the development of a multivariable signature related to the medicine type and compounding (concentration, etc.) derived directly from the medicine in the IV line 54. The signatures may for example be numeric vectors and will be used to reduce the risk of improper medicine types or wrong concentration of medicine are being delivered to the patient as will be discussed below. In the example of the spectroscope, the signature may be a multipoint spectrum together with a weight value.

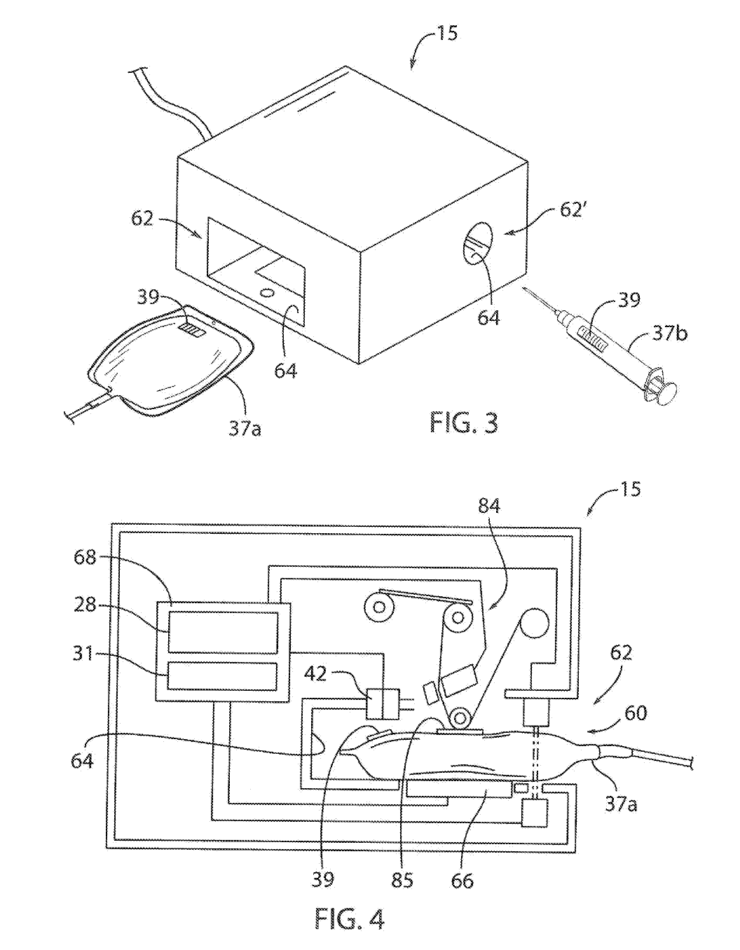

Referring now to FIGS. 3 and 4, in an alternative embodiment the medicine signature detector 60 may be shared among multiple, proximate medical pumps 10 by using a freestanding medicine verification appliance 15 holding the medicine signature detector 60. This approach reduces the cost of medicine analysis and verification. Generally, in this case, the appliance 15 may provide for entry ports 62 or 62′ operating respectively to receive different types of medicine containers 37, for example, with port 62 receiving IV bags 37a and port 62 receiving preloaded medicine syringes 37b within respective analysis chambers 64.

The medicine verification appliance 15 may include a processor 68 holding a stored program 28 and data files 31 to implement the verification process as previously discussed with respect to the embodiment of FIG. 2. This program 28 operates comparably for both of these embodiments and therefore will be described solely with respect to the medicine verification appliance 15.

Within the chamber 64, a reader 71, for example, an RFID reader or barcode reader or the like, may view a label 39 on the container 37 indicating the medicine type, concentration and patient identification along with other possible information including medicine delivery parameters such as flow rate and total volume. In the medical pumps 10 this may be accomplished by a handheld reader or by near field communication with an RFID tag or the like.

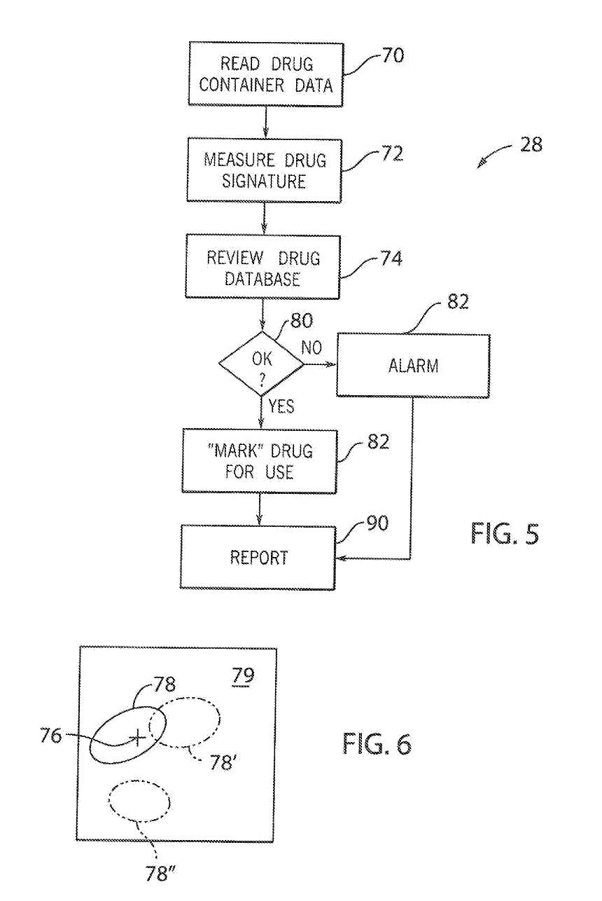

Referring also to FIG. 5, this information may be relayed to the processor 68 as indicated by process block 70.

As indicated by process block 72, parameters of the contained medicine in the container 37a may then be measured to develop a medicine signature. Principally, the signature will be obtained using the medicine signature detector 60 as has been discussed above which may, for example, transmit a laser through the container walls of container 37a to measure the medicine properties including typing concentration. The container 37 may be received on a scale 66 providing a weight to a processor 68 such as may form another component of a signature of the medicine within the container 37.

Referring momentarily to FIG. 6, the signature (“measured drug signature”) will provide a data point 76 generally within an N-dimensional signature space 77 which may include dimensions of weight, Raman spectral peaks and the like. As noted before, Raman spectroscopy may be associated with other sensing techniques described above to include additional dimensions to the signature space 77.

Returning to FIG. 5, information from process block 70 and 72 may then be reviewed at process block 74 against the data obtained from the medical record database 22 and drug database 23 (based on the information from process block 70) indicating generally the type and formulation of a medicine to be delivered to the particular patient.

Referring to FIG. 6, this information from the medical record database 22 and drug database 23 may be used to identify a signature profile 78 (“correct drug signature”) stored in the medical pump 10 or medicine verification appliance 15, or the signature profile 78 may be returned from the drug database 23 to the medical pump 10 or medicine verification appliance 15. The medicine signature profiles 78 also indicate a range within the signature space 77 in which data point 76 must lie in order to verify that the medicine to be delivered to the patient is the same as that indicated in the medical record databases 22 and drug database 23, this latter information derived, for example, from the physicians order or empirically determined and associated with a particular drug.

At decision block 80, if the data point 76 does not lie within the indicated range of a given signature profile 78, an alarm sequence of process block 82 may be entered. This alarm sequence may, for example, provide real time messages to appropriate individuals wirelessly to alert them of an error and/or may provide an alert to the healthcare practitioner 38 attending the patient using the medical pump 10 or medicine verification appliance 15 to provide an alerting tone or message. Manual override by the healthcare practitioner 38 may be possible through the entry of information identifying the healthcare professional which will be recorded for independent review. The alert will eventually be logged into a report and the electronic medical record 25 to provide an audit trail as indicated by process block 90 to be discussed below.

It will be appreciated that the identification provided by the data point 76 need not provide a comprehensive or unique signature for each given medicine and formulation but in fact there can be signature profiles 78′ for different drugs that overlap another signature profile 78. This may be readily accommodated with knowledge of the intended medicine and its formulation that is obtained from the electronic medical record database 22 or drug database 23 thereby preventing the need to identify medicines and concentrations in isolation. Generally it is necessary only that the signature profiles 78 distinguish among medicines and variations and formulations likely to be confused or to result from tampering. The evaluation of different drugs may also make use of different dimensions of the signature space 77 based on their distinguishing capabilities of those dimensions. It is desirable that the signature space 77 include dimensions that are sensitive not only to medicine type but also medicine concentration so as to be able to detect dilutions and the like as well as total drug amount to detect diversions. For the medical pump (50 of FIG. 2, total drug amount may be determined by a tally of pump volume (determined from the geometric qualities of the IV tube the three and the operation of the peristaltic pump 58) or a scale may be built into the IV bag hanger using load cell technology or the like.

The matching of decision block 80 may also look for negative signature values associated with negative signature profiles 78″ indicating, for example, adulteration or contamination of the medicine, such as common dilutions or the like. In this way the output may indicate not only incorrect medicines but also distinguish among different types of medicine error.

Referring to FIG. 5, if at decision block 80 the data point 76 lies within the indicated range of a signature profile 78, then the proper medicine type and formulation has been established and the medicine may be “marked” for use as indicated by process block 82. In the case of the pump 10 of FIG. 2, this marking may be virtual and applied to the container 37 connected to the IV pump 10 so long as that container 37 or its IV line 54 is not removed indicated by the line sensor or a loss of communication with the label 39 in the case of the near field reader.

In the case of the embodiment of FIG. 4, the marking may be physical by means of a label printer 84 which may print and apply an adhesive label 85 to the container 37 while the container 37 is in the chamber 64 or is data linked to, for example, serial number marked on the drug container and serving as an index to this data stored for example in the electronic medical record 25. The label 85 providing the data or serial number may be a tamper-resistant label as implemented either physically through the use of adhesives on the physical label 85 or may be made virtually tamper-resistant by encoding within a barcode or other optical code of the physical label 85 an encrypted form of information on the label 39 so that when the bag is moved to the pump 10, label 39 and the label 89 applied by the label printer 84 must match in order for the pump 10 to operate without an alarm. The information on the label 89 may be such as to prevent ready counterfeiting of that label, for example, by providing information that is not readily readable by a human and which incorporates information of the label 39, for example, using public-key encryption. It will also be appreciated that the label 89 may be an RFID tag label or may encode information in an RFID tag associated with label 39. Marking such as a fluorescent dye may be placed on the label 39 indicating that the drug container 37 has been used in the marking process to prevent reuse. This can be also accomplished through recording of information from the label 39 in the drug database 23.

Once the labeling process is complete, then at process block 90, information regarding the assessment of the medicine and its delivery may be provided to the remote electronic medical record database 22 and drug database 23.

Generally the label 85 or similar information recorded in the medical record database 22 and drug database 23 with respect to the label 85 will include a date and time stamp so that the medicine must be delivered to the patient 12 within a predetermined time or else the verification process would need to be repeated. This time may be extremely short for the embodiment of FIG. 2 since the verification may be done on a concurrent or continuous basis and may be as short as five minutes to 30 minutes for the medicine verification appliance 15 of FIG. 1. This delay may be logged in the medical record database 22 and drug database 23 and may provide real-time alerts to individuals.

Referring now to FIGS. 1 and 3, the medicine verification appliance 15 may also be used for an end-of-life audit mechanism for disposal of drugs for example in a secured container 33. In this case, authorized individuals may identify themselves using the keypad 36 associated with the appliance 15 indicating that the drug is to be discarded. The drug identity is unconfirmed using the sensor system 60 of the appliance 15 linked to for example a serial number on the drug package 37a. The appliance 15 they then compare the measured drug signature to a correct drug signature obtained from the database 22 (or this comparison can be performed elsewhere) and provides a label 85 attached to the drug container indicating that the drug is not for use and will be discarded. The author individual may then place the drug in the tamperproof secured container 33 providing an end-of-life verification of proper drug disposal.

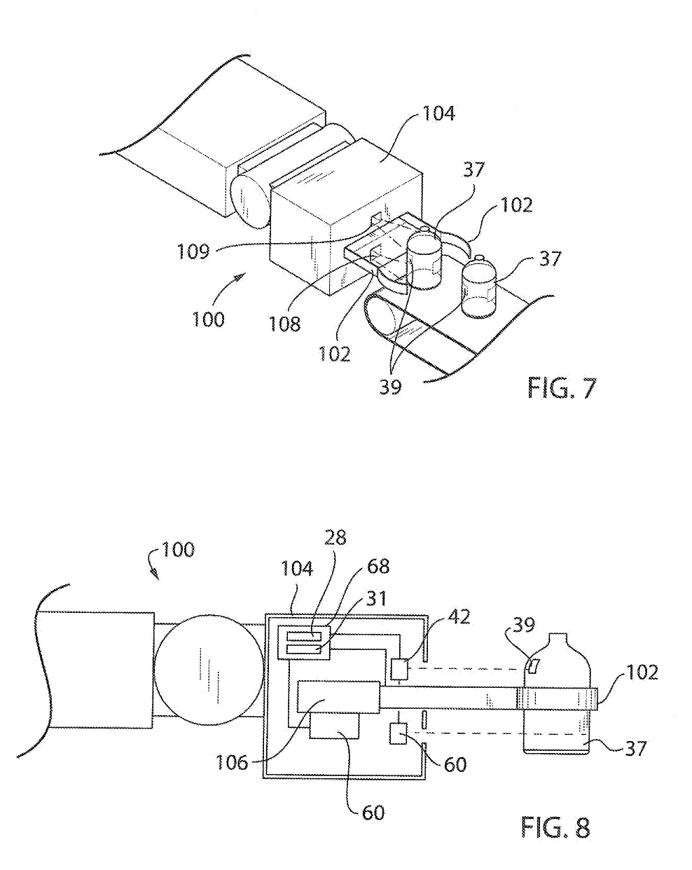

Referring now to FIGS. 7 and 8, the present invention may be incorporated into an automatic drug dispensing system, for example, such as are commercially available from a number of suppliers including Intelligent Hospital Systems Inc., of Winnipeg, Canada and such as are described in, for example, U.S. Pat. Nos. 9,043,019, 8,386,070, 7,610,115, which are hereby incorporated by reference. Such systems generally provide a multi-axis robotic manipulator 100 that can be maneuvered proximate to bottles, bags, syringes or other containers 37 holding medicaments for dispensing or compounding. The manipulator 100 may have opposed grippers 102 that can be actuated to move together and apart and thereby used to grasp the container 37 close to a housing 104 of the manipulator.

Within the housing 104, the grippers 102 may be controlled by an actuator 106 mounted on a scale 66 to provide a net weight of the container 37 (using known container weight) such as forms part of the medical signature described above. A forward facing medicine signature detector 60 may be exposed through a port 108 in the housing 104 to provide a signature of the medicament in the container 37 through the wall of the container while a context sensor 42 may scan a label 39 through a second port 109 in a manner similar to that described above, while the container 37 is held within the grippers 102. By allowing this process during movement of the container 37 the acquisition of a medical signature need not delay medicament dispensing or compounding.

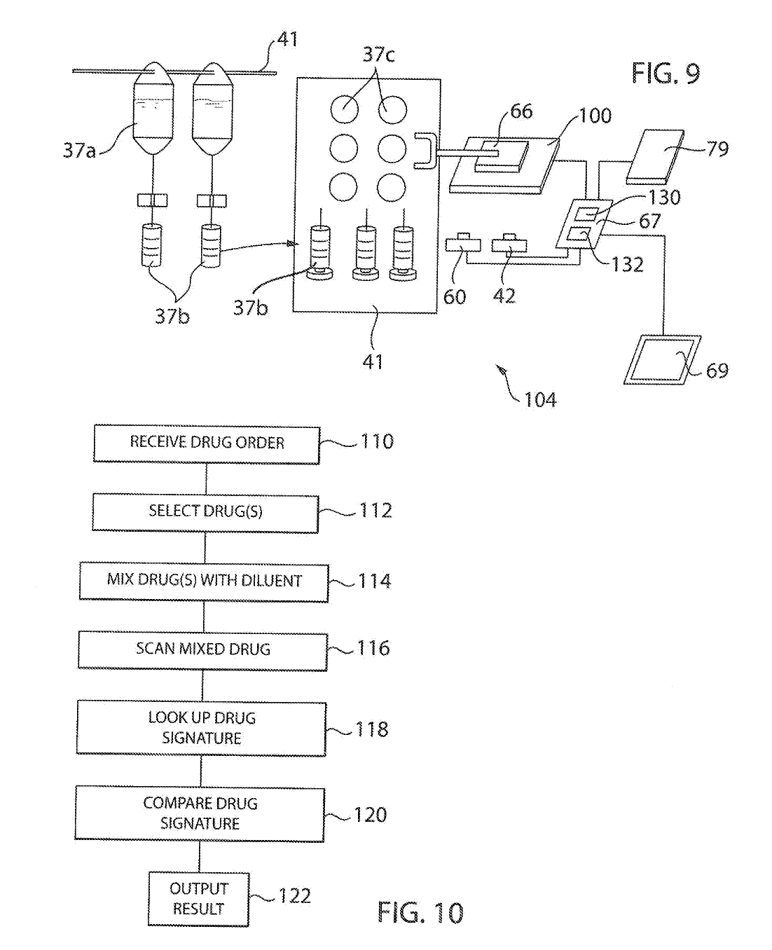

Referring to FIGS. 9 and 10, in an exemplary embodiment, the automatic drug dispensing system 101 may include a number of IV solution bags 37a containing diluents (e.g., sterile water or saline) used for mixture with dry form medicines (e.g., medicines in powder form) held in drug vials 37c or bottles. The IV bags 37a may be connected to the system 101 to dispense a desired amount of diluent into separate syringes 37b which may be more easily injected into the drug vials 37c.

An inventory rack 41 may be loaded with the solution bags 37a, drug vials 37b, syringes 37c, and other containers 37 holding medicines and diluents of different types for storage by the system until compounding. Certain medicines may be preloaded onto the inventory racks 41 in a warehouse and the preloaded inventory racks 41 delivered to the compounding or dispensing location, such as a pharmacy. In certain embodiments, limited amounts of drugs may be refilled by the healthcare practitioner 38 at the compounding or dispensing location when stock becomes low. The inventory may be monitored and controlled by a system processor 67 communicating with the central medical record system 14 or external medicine database 17 which tracks the drug inventory history and current and anticipated inventory need such that the proper amount of inventory is stored on the inventory rack 41. For example, when a drug order is received, the drug inventory may be adjusted to refill the drugs being dispensed or an amount of drug consumed over time may be used to determine future inventory supplies.

As indicated by process block 110, an incoming drug order may be received by the automatic drug dispensing system 101 providing a drug identity, formulation, and delivery rate and total quantity of the compound drug. If the medicines needed are not preloaded onto the inventory rack 41, the healthcare practitioner 38 may manually load the medicines onto the inventory rack 41.

As indicated by process block 112, the grippers 102 of the multi-axis robotic manipulator 100 may grip the needed drug containers 37 to fulfill the drug order. As the drug containers 37 are selected, the context sensor 42 may scan the labels 39 of the containers 37 to ensure that the proper drug ingredients are being selected for mixing. In the exemplary embodiment, for a drug order requiring a diluent and a dry medicine to be mixed, the manipulator 100 may grab a filled syringe of diluent 37b, previously dispensed from a solution bag 37a. The manipulator 100 may also grab a vial 37c to be combined with the diluent 37b.

As indicated by process block 114, the drug ingredients are mixed and the bottle shaken to reconstitute the drug. In the exemplary embodiment, the manipulator 100 may maneuver the drug containers to different filling stations/machines so that the syringe of diluent 37b is injected into the vial 37c containing the dry medicine. Then the manipulator 100 or filling stations/machines will shake the vial 37c to reconstitute the drug. The system 101 may include other transport mechanisms such as conveyor belts in order to help move the drug containers 37 to different stations/machines. Optionally, the drug may be aspirated from the vial 37c and filled into a separate drug container 37 for drug delivery, such as a new separate syringe.

As indicated by process block 116, the manipulator 100 will then maneuver the drug container 37 so that the signature detector 60 may take a reading of the contents of the container. Generally the signature detector 60 may provide quantitative outputs that permit the development of a multivariable signature related to the medicine type and compounding (concentration, etc.) derived directly from the medicine in the drug container 37. The detected signature profile may be modified depending on the drug container 37 through which the medicine is scanned to accommodate different thicknesses, colors, and physical and chemical properties of the drug containers 37. The scale 66 may also measure the net weight of the container 37 such as may form another component of a signature of the medicine within the container 37.

As indicated by process block 118, this information is then relayed to a system processor 67 holding a stored program 130 and data files 132, to implement the verification process as previously discussed according to previously described embodiments and which communicates with the medical record database 22 and drug database 23 to look up a signature profile related to the drug order and then, according to process block 120, compare the signature profiles and determine if the correct drug is being delivered as described above. This program 130 operates comparably with earlier described embodiments of the present invention.

As indicated by process block 122, the result of the comparison is conveyed to the medical professional. For example, if the detected drug signature does not match the indicated range of a given signature profile, an alarm sequence may be entered. The results of the comparison may be logged into a report and the electronic medical record 25 to provide an audit trail.

Once the drug compound is verified, the drug container 37 containing the mixed drug compound may be immediately labeled or tagged by a printer and labeler 79 of the automatic drug dispensing system 101. The physical label 85 may include medicine type and concentration or other formulation details of the drug in the container 37 and may further include an intended date of delivery and patient identifier identifying the patient to receive the drug. At least some of the information may be conveyed in a barcode or scannable QR code. The verification immediately before labelling and dispensing by the system ensures that the drug container 37 is properly labeled without tampering.

It will be appreciated that the signature verification process may occur for the compounded drug, such as an admixture with a diluent or a medication and a diluent. The verification may also be performed for each admixture, diluent or medication prior to mixing. In this manner, the verification process may occur throughout the compounding process of a drug (before each drug ingredient is mixed) and/or before dispensing the compounded drug from the system to the healthcare practitioner 38 or patient as indicated. For example, the drug identity may be verified for the diluent in the solution bag 37a, diluent in the syringe 37b, the medication in the vial 37c, and/or the completed admixture of medication and diluent prior to labeling and dispensing from the system 101 to the healthcare practitioner 38 or patient.

Optionally, a monitor 69 may be used by the healthcare practitioner 38 to input control information and/or output system status information. For example, the monitor 69 may be used to start, stop, or pause operation of the manipulator 100 performing compounding or dispensing operations. The monitor 69 may also output information related to verification of the signature profile 78, such as alarm sequence if there is an error or if there has been adulteration or contamination of the medicine. The error details may be displayed on the monitor 69 so that the healthcare practitioner 38 can assess the error. An error may automatically stop operation of the automatic drug dispensing system 101 and wait for an input from the healthcare practitioner 38 before resuming operation.

It will also be appreciated that the robot manipulator 100 may make use of the appliance described above with respect to FIGS. 3 and 4.

To the extent that automated dispensing systems rely on assumptions about proper labeling or positioning of medicines within the system, the present invention can provide an additional safety check of those assumptions guarding against dispensing errors caused by labeling errors or errors in the manufacture or delivery of the drugs.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but, arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What is claimed is:

1. An automatic drug dispensing apparatus comprising:
a cabinet holding a plurality of drugs in labeled containers providing machine-readable labels indicating drug contents, the cabinet providing limited access for restricting unauthorized personnel;
a manipulator adapted to transport at least one drug from the cabinet to aid dispensing outlet for receipt of the drug by medical personnel;
a sensor adapted to extract a drug signature dependent on a formulation of the drug by measuring properties of the drug imperceptible to a human observer;
an electronic computer executing a stored program to:
(1) receive a nominal identity of a drug to be dispensed;
(2) control the manipulator to select from the cabinet a container having a label matching the nominal identity;
(3) obtain from the sensor a measured drug signature of the selected drug in the drug container;
(4) use the nominal identity to determine a correct drug signature associated with the drug and to compare the correct drug signature with the measured drug signature; and
(5) provide an output indicating if the correct drug signature differs from the measured drug signature by a predetermined amount.

2. The apparatus of claim 1 further including combining a medicine and diluent and measuring the signature of the combined liquid medicine.

3. The apparatus of claim 1 where in the nominal identity includes chemical formulation and concentration and selecting a signature based on both formulation and concentration.

4. The apparatus of claim 1 further including a labeler configured to write the measured drug signature to a label on the plurality of drug containers.

5. The apparatus of claim 1 wherein the measured drug signature is a function of a chemical formulation of the drug.

6. The automatic drug delivery apparatus of claim 5 wherein the correct drug signature and measured drug signature do not uniquely characterize the chemical formulation of the drug.

7. The automatic drag delivery apparatus of claim 5 wherein the correct drug signature and measured drug signature are function of both chemical formulation and amount of the drug.

8. The automatic drug delivery apparatus of claim 1 further including a scale for measuring a weight of the drug and wherein the measured signature and correct signature include weight components.

9. The automatic drug delivery apparatus of claim 8 wherein the manipulator is supported by the scale.

10. The automatic drug delivery apparatus of claim 1 wherein the sensor is a spectrometer.

11. The automatic drug delivery apparatus of claim 6 wherein the sensor is selected from the group consisting of: Raman spectrometers, surface enhanced Raman spectrometers, nuclear magnetic resonance spectrometers, and optical spectrometers.

12. The automatic drug delivery apparatus of claim 11 wherein the spectrometer is a Ramen spectrometer.

13. The automatic drug delivery apparatus of claim 1 wherein the manipulator system comprises actuable grippers configured to move together and apart to grasp the plurality of drug containers.

14. The automatic drug delivery apparatus of claim 1 further including a network circuit for communicating with a remote electronic medical record system identifying a patient, prescribed drug, and prescription expiration for the prescribed drug, and wherein the correct drug signature is determined from the remote electronic medical record system.

15. The automatic drug delivery apparatus of claim 14 wherein the output is provided through a communication circuit to the remote electronic medical record system for recordation in the electronic medical record system.

16. A method of automatic drug dispensing comprising the steps of:
providing an automatic drug dispensing apparatus comprising a cabinet holding a plurality of drugs in labeled containers providing machine-readable labels indicating drug contents, the cabinet providing limited access for restricting unauthorized personnel; a manipulator adapted to transport at least one drug from the cabinet to aid dispensing outlet for receipt of the drug by medical personnel; a sensor adapted to extract a drug signature dependent on a formulation of the drug by measuring properties of the drug imperceptible to a human observer; and an electronic computer executing a stored program;
receiving a nominal identity of a drug to be dispensed;
controlling the manipulator to select from the cabinet a container having a label matching the nominal identity;
obtaining from the sensor a measured drug signature of the selected drug in the drug container;
using the nominal identity to determine a correct drug signature associated with the drug and to compare the correct drug signature with the measured drug signature; and
providing an output indicating if the correct drug signature differs from the measured drug signature by a predetermined amount.

17. The method of claim 16 further comprising the step of combining a medicine and diluent and measuring the signature of the combined liquid medicine.
